(19) United States
(12) Patent Application Publication
(10) Pub. No.: US 2022/0253881 A1
(43) Pub. Date: Aug. 11, 2022

(54) USING HYPERLINKS TO TRACK REFERRALS INCORPORATING PRODUCTS IN MULTI-LEVEL MARKETING SYSTEMS

(71) Applicant: KwikClick, LLC, Murray, UT (US)

(72) Inventor: Fred Cooper, Farmington, UT (US)

(21) Appl. No.: 17/588,811

(22) Filed: Jan. 31, 2022

Related U.S. Application Data
(60) Provisional application No. 63/143,304, filed on Jan. 29, 2021.

(51) Int. Cl. G06Q 30/02

(52) U.S. Cl. CPC G06Q 30/0214

(57) ABSTRACT

Methods consistent with the present disclosure allow purchasers of a product to become a product distributor as part a multi-level marketing (MLM) organization. Once a person has purchased an item (a product or service) via their user device, they may be allowed to share information associated with the item with other user devices. This process may allow users to select products offered for sale by the MLM organization after which hyperlinks may be generated that are associate a universal resource locator (URL) with item identification and referral information. When a user device accesses the hyperlink, that user device may access a computer that collects data regarding user access. This computer may then redirect the user device to a webpage identified by the URL that sells the item. When a user purchases the product, commissions may be paid out to a set of related distributors that previously purchased the product.

### CROSS-REFERENCE TO RELATED APPLICATIONS

The present disclosure claims priority benefit of U.S. provisional patent application 63/143,304 filed on Jan. 29, 2021, the disclosure of which is incorporated herein by reference.

### BACKGROUND OF THE INVENTION

### Field of Invention

The present disclosure is generally related to custom hyperlinks in multi-marketing systems. More specifically the present disclosure is directed to using custom hyperlinks to provide product promotions, products, and commissions to related users in multi-marketing systems.

### Description of the Related Art

A Multilevel marketing (MLM) commission payment system is a sales methodology used by some direct sales companies, which may be used to encourage existing distributors to recruit new distributors who are paid a percentage of their recruits' sales. The recruits are “downline” of the distributors. The term “downline” is used to describe sellers of products that have been sponsored by a sponsor (i.e. a sponsee of the sponsor) to sell products. The term “upline” is used to refer to sellers of products that sponsored a given sponsee. As such, sponsors are distributors that are upline from their sponsees and sponsees are distributors that are downline from their sponsors. Terminology used in the art refer to a recruit or a new person (i.e. distributor) sponsored by a sponsoring user is downline of the newly sponsored person, where the sponsoring user is “upline” of the newly sponsored person. Such persons or distributors also make money through direct sales of products to customers. Amway, which sells health, beauty, and home care products, is an example of a well-known direct sales company that uses multilevel marketing.

Multilevel marketing (MLM) has been found to be a legitimate business sales methodology if participants receive something of value for their participation in an MLM organization. Even though Amway has a pyramid like structure where sponsors may receive more benefits than new recruits, Amway has been judged to be a legitimate organization because all participants receive the benefit of purchasing products at a competitive price. One problem with some MLM organizations referred to as “pyramid schemes” is when new recruits do not receive any benefit based on just joining the MLM organization. One characteristic of a MLM “pyramid scheme” versus a legitimate MLM organization is that in a “pyramid scheme” new recruits receive benefits based primarily from signing up other new participants. Thus, money received from the new recruits only pays people above them or at the top of the organization rather than new recruits or others who actually perform work (e.g. the selling of products). As such, a “pyramid scheme” is also characterized by paying sponsors rather than individuals that perform the work. This is why “pyramid schemes” are illegal. These “pyramid schemes” involve taking advantage of people by pretending to be engaged in legitimate multilevel or network marketing activities, when their greater focus is on recruitment rather than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Each MLM company dictates its own specific financial compensation (or commission) plan for the payout of any earnings to their respective distributors. Compensation may be in the form of commissions that require a participant to enter a contract, pledging exclusivity in participation to the MLM company paying the commissions. Currently MLMs require that users become members in order to distribute a product and these users have no way to allow anonymous buyers to be part of a member's multilevel marketing group from which commissions may be earned. Compensation plans of MLMs pay out to participants typically from two primary possible revenue streams. The first is paid out from commissions of sales made by the participants directly to their own retail customers. Retail customers are not tracked or known by the MLM company therefore MLM companies cannot substantiate either their existence or their sales volume individually or collectively. The second is paid out from commissions based upon the wholesale purchases made by other distributors below the participant who have recruited those other participants into the MLM; in the organizational hierarchy of MLMs, these participants are referred to as one's downline distributors.

MLM salespeople (distributors) are, therefore, expected to sell specific MLM company products directly to end-user retail consumers by means of relationship referrals and word of mouth marketing, but most importantly they are incentivized to recruit others to join the company's distribution chain as fellow salespeople so that these can become downline distributors.

Currently, no large financially successful MLM salesperson (distributor) can earn commissions of any significance or take full advantage of a commission compensation plan without personally recruiting others into their downline.

All MLM compensation companies permanently place new recruits in a tree structure for calculating commissions. Once placed, all sales made by that distributor from their personal purchases, or from new recruits they sponsor, generate commissions only for their sponsor and upline, regardless of all future products sold.

MLM companies offer goods or services offered specifically and exclusively by them. The large markups required for payment of commissions necessitate MLM companies to limit what products they can offer such that they will be financially indifferent regarding which product a distributor chooses to buy.

MLM companies currently have a “pay to play” requirement. Distributors are required to make monthly purchases, and/or meet downline group sales volumes to qualify for commissions. Thus the mode, median and average purchase size of a Distributor in MLMs is virtually equal to this minimum qualification requirement and no greater.

Distributors only qualify for commissions if they have purchased a minimum threshold of products offered exclusively by the MLM company as set forth by an MLM company's commission program rules.

Currently, in order to join an MLM organization, there is an initiation fee, which may be a barrier against those that just wish to refer a single product they like. Current multi-level marketing (MLM) systems do not take full advantage of the internet and how consumers can influence other consumers to make purchases. Also, current MLM systems do not incorporate incentivizing users of a multilevel marketing system by offering a dynamic commission tree. In addition, there is no current MLM system that utilizes the money or funds dedicated to discounts or coupons to be reincorporated into a multilevel marketing system to incentive consumers to make purchases and advertise the product that they purchased. Thus, there is a need to provide users a method to join an MLM for free, being simple to use and allow the MLM commissions provided to purchasers, provided by the sellers to allow the purchasers to market the seller's products.

Currently, a company that is not utilizing an MLM structure for paying commissions for sales, cannot introduce one without developing a compensation plan specific for their company, following the methodology outlined above, and thus requiring them to become and subsequently adhere to applicable MLM law.

Current MLM organizations also do not allow their members to create marketing materials that may help motivate other individuals to join the MLM organization or to motivate members to purchase products offered for sale by the MLM organization. What are needed are new types of systems and apparatus that allow MLM members create and share marketing materials. What are also needed is the ability to propagate sales of products without the need for participants to identify themselves.

Further, there is currently no systematic way for consumers to promote any brand of preference outside the MLM industry and be paid in an MLM commission methodology without subjecting themselves to a contractual signup, initiation fees, minimum recurring purchases sales, volume requirements, recruiting, exclusivity, and permanent tree placement (resulting in only upline distributors earning commissions).

This system has value because it allows users to become a part of the MLM system simply by clicking a referring link and buying the product. What are needed are systems where a user does not need to be referred to be able to refer the product to others. In addition, users can propagate the product without ever identifying themselves and collecting their commission.

Further, there is currently no systematic way for consumers to promote any brand of preference outside the MLM industry and be paid in an MLM commission methodology without subjecting themselves to a contractual signup, initiation fees, minimum recurring purchases sales, volume requirements, recruiting, exclusivity, and permanent tree placement (resulting in only upline distributors earning commissions).

### SUMMARY OF THE PRESENTLY CLAIMED INVENTION

The presently claimed invention is directed to a method that may be implemented as a non-transitory computer-readable storage medium. In one embodiment, a method includes identifying an item identifier (ID) associated with an offering to sell the item and a universal resource locator (URL) that points to the offering to sell the item. This method may also include storing information that associates a generated hyperlink, referral information, and the URL with the item ID. The hyperlink may point to an administration computer, where the referral information is associated with a set of distributors that previously purchased the item. Each of the set of distributors belong to a same multi-level marketing (MLM) tree. After the information is stored, a user device is redirected to receive product offering information. The data associated with the hyperlink may have been received based on the user device accessing the hyperlink. Next, the method may receive purchase validation data that identifies that a user of the user device purchased the item. Commissions may then be distributed to the set of distributors based on receipt of the purchase validation data, the stored association information, and each of the distributors belonging to the same MLM tree.

In a second embodiment a processor executing instructions out of a memory may identify an item identifier (ID) associated with an offering to sell the item and a universal resource locator (URL) that points to the offering to sell the item. Here again this may also include storing information that associates a generated hyperlink, referral information, and the URL with the item ID. The hyperlink may point to an administration computer, where the referral information is associated with a set of distributors that previously purchased the item. Each of the set of distributors belong to a same multi-level marketing (MLM) tree. After the information is stored, a user device is redirected to receive product offering information. The data associated with the hyperlink may have been received based on the user device accessing the hyperlink. Next, the method may receive purchase validation data that identifies that a user of the user device purchased the item. Commissions may then be distributed to the set of distributors based on receipt of the purchase validation data, the stored association information, and each of the distributors belonging to the same MLM tree.

### BRIEF DESCRIPTION OF THE DRAWINGS

FIG. 1 illustrates different sets of computer systems that may be included in a computer networked multi-level marketing system.

FIG. 2 illustrates a series of steps that may be used to enroll new products as products that may be offered for sale via a multi-level marketing organization.

FIG. 3 illustrates a series of actions that may be performed when user activity is tracked.

FIG. 4 illustrates steps that may be performed when purchase related activities of a user are tracked.

FIG. 5 illustrates a computing system that may be used to implement an embodiment of the present invention.

### DETAILED DESCRIPTION

Methods consistent with the present disclosure allow purchasers of a product to become a product distributor as part a multi-level marketing (MLM) organization. Once a person has purchased an item (a product or service) via their user device, they may be allowed to share information associated with the item with other user devices. This process may allow users to select products offered for sale by the MLM organization after which hyperlinks may be generated that are associate a universal resource locator (URL) with item identification and referral information. When a user device accesses the hyperlink, that user device may access a computer that collects data regarding user access. This computer may then redirect the user device to a webpage identified by the URL that sells the item. When a user purchases the product, commissions may be paid out to a set of related distributors that previously purchased the product. These distributors may be related by referral information that is a chain or tree of distributor users that each referred information for purchasing the item to another one of the user/distributors that are part of the same chain or tree of distributor users.

This may be accomplished by providing materials to potential buyers that allow those potential buyers to quickly link to product offerings. This may include associating a product with a hyperlink and with one or more users that participate in multilevel marking activities, when new users or new products are enrolled as part of an MLM organization.

The present disclosure is also directed to a system and method to allow sellers of products to enroll an individual product in a multilevel marketing (MLM) type commission system (system), where a good or service (i.e. product) is offered by any vendor and sold to a first purchaser—who at the time of the purchase becomes a system user (or registered user/participant/distributor). This user has a code tied to the specific product(s) offered by the participating vendor. The code may be shared by this first user passively (by a purchase) or actively (by request) to a new buyer. The code share makes the new buyer a user of the system. The new user, like the first, will be allowed to purchase the product and provide advertisements to other purchasers. Commissions paid to respective downline purchasers for a single product may be limited by a preset number of defined levels. After a product is purchased, commissions are paid out to each respective purchaser according to the defined commission levels. A wave of creating and recreating users may be based on purchases and linking them together may be part of an iterative process. Remuneration on this specific product is paid to all or numerous users linked together in the system, each time a purchase is made. The links may be unique and fixed to each good or service being referred.

Once a new buyer purchases a product, that new user may also be assigned a unique code that may be considered a child code of a parent code that is assigned to a user that provided the new buyer with materials that promote the purchase of the product that they purchased. The parent code may be shared by a first user passively (by a purchase) or actively (by sending a request) to the new buyer. This type of code sharing makes the new buyer a user of the system. The new user, like the first user, will be allowed to purchase the product and provide advertisements to other purchasers. New users may also be allowed to create new product offerings. Commissions paid to respective upline or downline purchasers for a single product may be limited by a preset number of defined levels. After a product is purchased, commissions may be paid out to each respective purchaser according to the defined commission levels. A wave of creating and recreating users may be based on purchases and linking them together as part of an iterative process. Remuneration on this specific product is paid to all or numerous users linked together in the system, each time a purchase is made. The links may be unique and fixed to each good or service being referred. Payments may be distributed directly into a back account of a user, as credits to a mobile device, as credits to a credit/cash/debit card, may be distributed using a form of cryptocurrency, or may be distributed by other means.

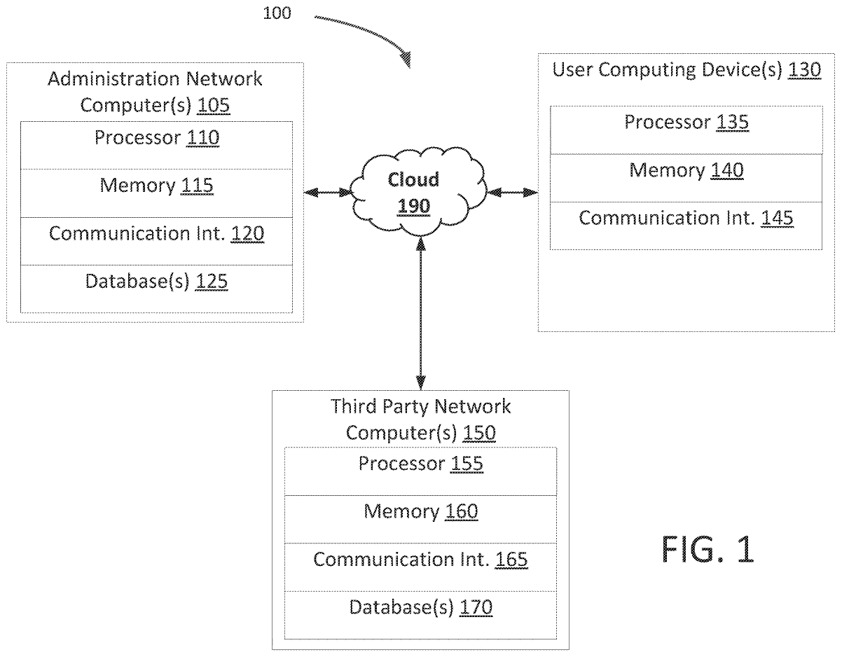

FIG. 1 illustrates different sets of computer systems that may be included in a computer networked multi-level marketing system. The various computers of FIG. 1 may implement functions consistent with a multilevel marketing (MLM) system 100 or MLM organization. FIG. 1 includes one or more administration computers 105, user computing devices 130, and third party network computers 150 that may communicate via the Internet or a cloud computing environment 190. Each of the different computers of FIG. 1 may include a processor, a memory, and a communication interface. Some of the computers illustrated in FIG. 1 include one or more databases where data relating to the operation of MLM system 100 may be stored. In operation, each of the respective computers of FIG. 1 may execute instructions out a memory local to that processor and may communicate with other computers via a respective communication interface when products are added to or sold by members of a MLM organization.

Administration computer 105 includes processor 110, memory 115, communication interface 120, and database(s) 125. User computing device 130 includes processor 135, memory 140, and communication interface 145. Third party network computer 150 includes processor 155, memory 160, communication interface 165, and database(s) 170. A user of user device 130 may interact with a user interface (not illustrated) at user device 130 when accessing information stored at administration network computer 105 database(s) 125 or when accessing information stored at third party network computer 150 database(s) 150. Such interactions may allow a user to identify products that they can sell, identify new users, and receive information identifying information relating to products they distribute as a member of an MLM organization.

Processor 110 of administration network computer 105 may execute instructions from one or more software modules when functions associated with the registration of new products and users, the sale or distribution of marketing materials, or when commissions are distributed to users that act as distributers (or sales representatives) of products. When software program code executed by processor 110 is organized as a set of multiple different software modules, those modules may include an administration network base module, an administration network calculation module, an administration network commission module, an administration network advertising module, an administration network product enrollment module, a hyperlink creation module, and a hyperlink tracker module. Computers 105 of an administration network may include or access one or more databases that may include an administration database, a compensation database, a hyperlink database, and a landing page database.

A user or distributor may refer to the non-salaried workforce selling the company's products or services, while the earnings of participants of an MLM organization may be associated with a pyramid-shaped or binary compensation commission system. A product may refer to an article or substance that is manufactured or refined for sale. A service may refer to a system supplying a public need such as transport, communications, or utilities such as electricity or water. A service may be an act of dealing with a customer in a store, restaurant, or hotel by taking their orders, showing, or selling them goods. Additionally, a service may be work that someone does or time that someone spends working for an organization, or a business that offers a particular type of help or work.

The administration network computer 105 may accept sellers (third parties), where a “single product tree” multi-level marketing method is formed, comprising the steps of, providing at least one product, providing an MLM system with a seller's commission structure, and providing at least one seller of a product with its associated commission structure. The term “single product tree” or “product tree” refers to a unique structure for associating distributors of an MLM organization where products are used to identify relationships between distributors and commissions paid to related distributors. This “single product tree” structure allows for a particular user to be considered a sponsor or any other user based on that user sending promotions to other users to purchase a product that those other users were not previously associated with.

The administration network computer 105 may also provide a plurality of buyers/distributors, allow the at least one first seller to enroll a product to the MLM system, and allow at least a first buyer/distributor to purchase the product. Other functions that may be performed by the administration network computer 105 include allowing the at least the first buyer/distributor to advertise the product to other potential buyers/distributors and allowing at least a second buyer/distributor to buy the advertised product. Here the seller may set a commission structure for a product, may enroll the product into the MLM system, may allow the first, second and so on purchasers/distributors to purchase and advertise the product.

Instructions of an administration network product enrollment software module may allow users to create a first referral code that may be stored at a database 125 of FIG. 1. Such a database may be referred to as an administration network hyperlink database. Instruction of an administration network hyperlink creating module may allow users to create a hyperlink by combining the user specific referral code, discussed above, with information of what may be referred to as a “landing page.” Such a “landing page” may be webpage hosted at third party network computer 150 and that landing page may include information associated with purchasing a product or purchasing a product at discount rate. This landing page data may be accessed by or copied to an administration network computer 105. In certain instances, a discount may be applied based on a code that is provided to the third party network computer 150 via a specific landing webpage. A prospective buyer may be allowed to enter a code via a user interface associated with the landing webpage or a code may be received automatically after a user selects (or clicks on) a referral hyperlink at their user device. Alternatively, or additionally, such landing pages or landing webpages may be hosted by administration network computer 105.

Functionality of a landing webpage may be invoked after a referral or set of marketing materials are displayed on a display of a user device. These materials may include a universal resource locator (URL) or an embedded URL that when selected results in a browser of the user device to receive content of the landing webpage. Here, a code may be entered by a user to gain a discount or that code may be automatically provided to the landing webpage and the user device may be sent a discount offer to purchase a product. This offer may be displayed on a display of the user device and a user by interacting with their user device may order the product. Once purchased and potentially after the user receives the ordered product, commissions may be paid to upline members of an MLM organization that are associated with the user that purchased the product. Marketing materials provided to users via their user devices may include various types of media, such as photos, videos, text, sounds, haptics, online product descriptions, etc. for enhanced marketing.

Once products have been enrolled with a commission structure, the administration network computer 105 may allow the purchasers/distributors to receive a commission based upon the seller's product commission structure. A distributor may refer to the non-salaried workforce selling the company's products or services. Here the earnings of the participants may be derived from a pyramid-shaped or binary compensation commission system. The term product may refer to articles or substances manufactured or refined for sale. Product may refer to an individual product, a line of products such as unique brand and model of drill, or a group of products such as all power tools.

A service may refer to a system supplying a public need such as transport, communications, or utilities such as electricity or water. A service may also be an act of dealing with a customer in a store, restaurant, or hotel by taking their orders, showing, or selling them goods. Additionally, a service may be work performed by a person or may relate to an amount of time that someone spends working for an organization or business that offers a particular type of help or work. The system 100 of FIG. 1 may distribute commissions according to an MLM tree or commission tree that is a payment structure in which commissions are given out at different percentages at different levels of the MLM tree. In such a system, distributors (users) that perform the sale or that are at a level that is “closer” to the distributor that performed the sale may receive larger commissions than distributors that are “farther” from the sale. Users that are more than some number of steps (e.g. 5) away from a sale may not receive a commission at all.

In another example, a first MLM distributor that performs a sale may receive a higher percentage than a second distributor that sponsored the first MLM distributor, and a third MLM distributor that signed up the second MLM distributor may receive a lower commission than the commission received by the second MLM distributor for the sale. Distributors in an MLM tree may be referred as “downline” or “upline” distributors depending on where different users rank on the MLM tree.

For example, a first user that sponsors (MLM distributor) a second user is “upline” from the second user (MLM distributor) and the second user is “downline” from the first user in the MLM tree. Furthermore, any user/distributor that the second user sponsored would be considered downline from the second user and could be downline from the first user as well for a given MLM product tree. When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user for this product. Because of this, the second user is not relegated to always be downline from the first user just because the first user originally sponsored the second user to become an MLM distributor.

An MLM system which may be referred to as network marketing, may be a business model that depends on person-to-person sales by independent representatives, who may work from their home. A network marketing business may require the independent representatives to build a network of business partners or salespeople to assist with lead generation and closing sales. An end of life of MLM tree may refer to the end of the MLM tree in which the commission tree may be restructured or eliminated. For example, further participants in the MLM may not receive a commission, the commission tree may “start up” (be reinitiated from a starting point) again, or the commission tree may be restructured in some other way. An existing MLM system may refer to currently existing or established companies that use the sales strategies to encourage existing distributors to recruit new distributors who are paid a percentage of their recruits' sales.

The administration network computer 105 may perform data security functions as well as functions associated with operation of an MLM algorithm that may calculate user compensation. Administration network computer 105 may be able to connect to a software application store, like the “Apple App Store,” where a program application can be downloaded from. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline participants.

A set of commission program instructions may cause a computer processor 110 at the administration network computer 105 to continuously poll for user data (e.g., data of a user who may be a product purchaser or product distributor) from another processor executing a set of discount program instructions at a third party network computer 150. Once the processor 110 of the administration network computer 105 receives the user data, commissions may be calculated using the commission program instructions. These commissions may be calculated based on data stored in an administration network compensation database. Downline and upline commissions for the other users (product purchasers/distributors) within the MLM tree may be paid. The administration network compensation database may be included within the administration database 125 of FIG. 1 or it may be a separate database accessible by the administration network computer 105. Alternatively, instead of the administration network computer 105 polling a third party network computer 150, the third party network computer 150 may send the user data to the administration network computer 105 after a sale has been made.

An upline may refer to the MLM distributors that recruits work for as salespeople to sell the products or services. A downline may refer to the recruits the MLM distributors are able to secure as participants in the MLM system. Downline MLM trees may go across country boundaries and commissions may be paid out for an MLM tree even though the participants in the MLM tree may not reside in the same country. The commissions may be calculated for the appropriate exchange rate to ensure participants are paid in their residing countries currency in the correct amount.

A processor executing the commission program instructions may continuously poll for user data from the third party network computer 150. The administration network computer 105 may then receive the user data from the third party network computer 150. Then the administration network computer 105 may determine whether the user entered a code. If the user did enter a code, the processor at the administration network computer 105 may extract the code and then access the administration network compensation database to identify one or more different spheres of influence or potential product purchasers/distributors levels. Such a code may have been received from user device 130 based on user inputs. A sphere of influence for a given product may be associated with a chain of upline and downline distributors that sold a particular product, where each downline user may have been sponsored to sell the product by an upline user.

The processor 110 at the administration network computer 105 may also associate a code for each of the different spheres of influence. The administration network computer 105 may then extract a corresponding commission for the code that was retrieved from in the administration network compensation database. The administration network computer 105 may then send the commission to the user (purchaser/distributor) via communication interface 120 and the Internet or cloud 190. The administration network computer 105 may track profits and payments as well as track taxes for users enrolled in the MLM system. The tracking of profits and payments may refer to the MLM system tracking the profits of the MLM and tracking the payments or commissions paid out to participants. The tracking of taxes may refer to tracking the commissions provided to participants for tax purposes. Then the administration network computer 105 may also compare the extracted code to data stored at an administration network code database that may store a list of users and code sent to followers. This administration network code database may be the same database as the administration database 125 of FIG. 1 or it may be another database accessible by the administration network computer 105. The administration network computer 105 may extract a user ID and sphere of influence or potential purchasers/distributors by using the extracted code.

The administration network computer 105 may then compare the extracted sphere of influence or potential purchaser/distributor to data stored at the administration network compensation database. The administration network computer 105 may then use the extracted sphere of influence data to extract a corresponding commission from the administration network compensation database. The administration network computer 105 may then send the commission to an upline user. If the user did not enter a code, the administration network computer 105 may then initiate a set of administration network advertising program instructions.

The administration database 125 may store data received from various third parties (various sellers) that are part of a set of MLM trees. This data may contain an item ID, description of the item, an original cost of the item, a discount for the item, a cost of the item with the discount, a compensation plan decay rate, and a link to the item. An advertising link may refer to a link that directs a consumer to a product, service or good.

TABLE 1
Administration Database Data

| Third Party | Home Depot | Home Depot | Furniture Store |
|---|---|---|---|
| ID | 654123 | 789654 | 123789 |
| Item | Drill | Table Saw | Couch |
| Original Cost | $59.00 | $119.00 | $999.00 |
| Discount | 15% | 10% | 10% |
| Discount Cost | $50.15 | $107.10 | $899.10 |
| Compensation | 50% | 50% | 30% |
| Decay Rate | | | |
| Link | HDDrill654123 | HDTSaw789654 | FSC123789 |

Table 1 table displays data that may be stored at the administration database 125 of FIG. 1. When the administration network computer 105 receives item data from third party network computer 150 it creates a link for the item, stores the received data in the administration network administration database 125, and sends the created link back to the third party network computer 150. The administration network database 125 may be used to store data collected from various third parties that enrolled in the multi-level marketing system 100 of FIG. 1. The administration network database 125 may store the name of the third party, the ID for an item, a description of the item, the original cost of the item, the discount provided by the third party, the cost of the item with the discount, the compensation decay rate or how the downline commissions are calculated, and the link to the item.

The administration database 125 may store data that the administration network computer 105 may access when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media, and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

As mentioned above user device 130 may include a memory 140, a processor 135, and a communication interface 145. The processor 135 of user device 130 may execute instructions out of the memory 140 when a user of user device 130 registers as a member of an MLM organization. Other tasks that a user may perform on user device 130 could include, identifying or connecting with other user devices (e.g. follower user devices), preparing advertisement information to share with follower user devices, receiving advertisement information prepared by other users, accessing product promotions at the third party network computer 150, and purchasing products based on offerings received from the third party network computer 150. Each of the tasks performed by user device 130 may include sending and receiving communications with the administration network computer 105, the third party network computer 150, or other user devices. Promotions prepared at a particular user device may be shared with other user devices via administration network computer 105, third party network computer 150, a social media network computer, or directly from one user device to another. User devices may also be required to download and install an application program from an application store, such as the “Apple App store” as part of a process for registering as a member of an MLM organization.

The user device communication interface 145 of FIG. 1 may send and receive data via a communication network 190 which may be a wired and/or a wireless network. User device(s) 130 may be devices such as a laptop computer, a smartphone, a tablet, a desktop computer, or smart speaker, for example.

As discussed above the third party network computer 150 of FIG. 1 may include a computer processor 155, a memory 160, and communication interface 165. This third party network computer 150 may be controlled by various third parties, such as retail stores (stores that sell product consumables, services, franchises, service networks, large box stores) or e-commerce sites that allow e-commerce sales. Such e-commerce sites may include an e-commerce shopping cart, that offer items to users at a discount, such as a product discount, in order to use the MLM system of FIG. 1. A franchise may refer to an authorization granted by a government or company to an individual or group enabling them to carry out specified commercial activities, e.g., providing a broadcasting service, or acting as an agent for a company's products. Product consumables may refer to goods by individuals and businesses that must be replaced regularly because they wear out or are used up. Service networks refer to a collection of people and information brought together on the internet to provide a specific service or achieve a common business objective, such as Angie's List. E-commerce sale may refer to sales of goods and services where the business takes place over the internet, an extra-net, Electronic Data Interchange (EDI), or other online system.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes and other parameters the owner of the site has previously set. Retailer may refer to a person or business that sells goods to the public in relatively small quantities for use or consumption rather than for resale. Product discounts may refer to a reduced price or something being sold at a price lower than that item is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance.

The third party network communication interface 165 of FIG. 1 may send data and receive via a communication network 190 which may be a wired and/or a wireless network.

The third party network discount program instructions may be executed by a computer processor 155 after being initiated by a set of third party network base program instructions. These instructions may cause the processor 155 at the third party network computer 150 to prompt a user device for a discount code and to compare a received code to data stored at a third party network third party database 170. When a code received from a user matches data stored at the database 170, a discount for the selected item may be applied and an order for a product may be processed.

The communications network 190 of FIG. 1 may be the Internet or a cloud computing network. This communication network or any of the communication network interfaces 150 or 170 discussed herein may be a wired and/or a wireless network. Such a communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

Table 2 illustrates a set of data referred to herein as “landing page” data. This data cross-references an item identifier (ID) with an item name, a vendor (e.g. a 3^{rd} party vendor), and a universal resource locator that points to a website of the vendor where an item (e.g. a product or service) is offered for sale. This landing page data may be stored in a landing page database or may be stored as landing page data stored at a database that stores various different types of data accessible by an administration network computer, such as database 125 of administration computer 105 of FIG. 1 or this data may be stored at a database of a 3^{rd} party vendor accessibly by the administration network computer. This landing page data may be accessible by software modules executable at an administration computer when the administration computer performs tasks of selling products and services offered via participation in an MLM organization. Table 2 identifies that item id 654123 is associated with a item named “drill” product sold by a 3^{rd} party vendor Home Depot at URL https://www.homedepot.com/ . . . Table 2 also cross-references item ID 789654 with a “table saw” product also offered for sale via a Home Depot URL; cross-references item ID of 123789 with a “couch” sold by vendor “Furniture Store” at URL https://www.bobsfurniture.com/ . . . ; and cross-references item ID 456812 with “cold medicine” product offered by a “pharmacy” at URL https://www.vons.com/ . . .

TABLE 2
Landing Page Data

| | Item | 3rd Party | |
|---|---|---|---|
| Item Id | Name | Vendor | Landing Page URL |
| 654123 | Drill | Home Depot | https://www.homedepot.com/ . . . |
| 789654 | Table Saw | Home Depot | https://www.homedepot.com/ . . . |
| 123789 | Couch | Furniture | https://www.bobsfurniture.com/ . . . |
| | | Store | |
| 456812 | Cold | Pharmacy | https://www.vons.com/ . . . |
| | Medicine | | |

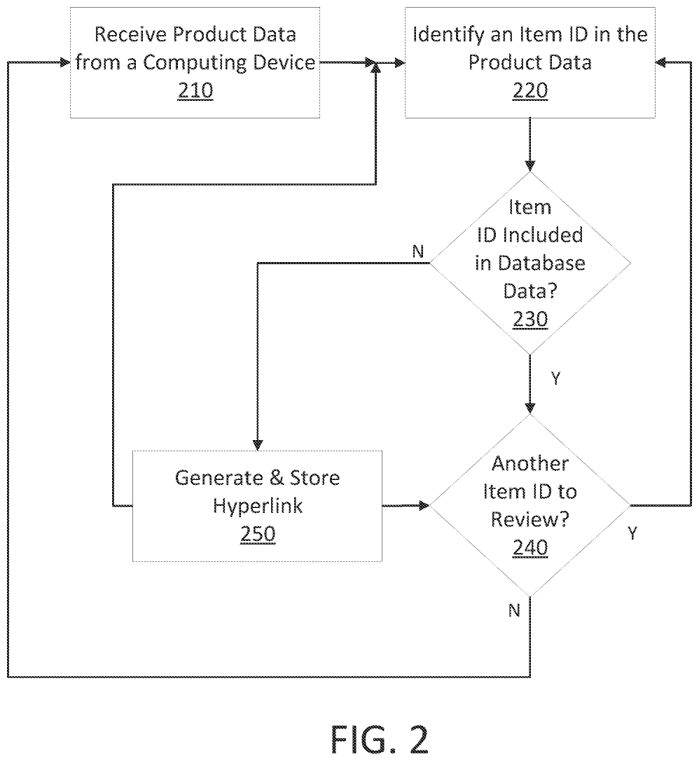

FIG. 2 illustrates a series of steps that may be used to enroll new products as products that may be offered for sale via a multi-level marketing organization. The process of FIG. 2 may also allow new users to enroll as new distributors of products offered for sale by a multi-level marketing (MLM) organization. This process may include generating hyperlinks that may be included with messages that refer products or services for sale or included in materials that market products. The steps of FIG. 2 may be performed by an administration network computer that modifies universal resource locators (URLs) stored with the landing page data discussed above. This landing page data may be stored at a database accessible by an administration network computer.

FIG. 2 begins with step 210 where data is received that identifies item IDs, corresponding item names, and URLs where respective products or services are offered for sale. This data may be retrieved from a landing page data accessible by a computer that administrates sales of an MLM organization. As reviewed above, this landing page data may cross-reference an item ID, with an item name, a vendor (e.g. a 3^{rd} party vendor), and a URL (landing page URL) of a webpage where the item is offered for sale.

The product data received in step 210 may be a selection received from a user device of a user that distributes or wishes to distribute a product. In such an instance, after a user purchases a particular product, that user may be allowed to act as a distributor of that product. This user may become a distributor by identifying the product after which this new distributor may be allowed to share marketing materials related to that product with other user devices. Methods consistent with the present disclosure may store and track sales of this product based on the marketing efforts of this new distributor such that commissions may be paid to this new distributor and potentially to other related distributors of that product.

Next in step 220 of FIG. 2 a first item identifier (ID) may be identified as being included in the landing page product data. Program flow may move to determination step 230 that may identify whether a set of hyperlink database data already stores information relating the item ID. This hyperlink database data may be stored in the database that also stores the landing page data or may be stored at another database accessible by the administration computer. This hyperlink database data may associate item IDs with product names, referral codes, user IDs, and generated hyperlinks as reviewed below in table 3. The process of making entries into the hyperlink database may include generating new entries when distributors or potential distributors purchase a product offered for sale by a vendor associated with an MLM organization. User IDs may be assigned based on any desired criterial and may be associated with an internet protocol (IP) address, a machine identifier or address (MAC address), a random number, a hash of data, or some other combination of user specific information.

When determination step 230 identifies that data associated with the item ID identified in step 220 is not stored as hyperlink database data, a process for creating a new entry the database may be initiated. The process of creating entries in the database may include generating a hyperlink in step 250 of FIG. 2. This generated hyperlink may be used to direct user devices to access the administration computer when items (products or services) are offered for sale via an MLM organization. This generated hyperlink may also include information that links to the URL that promotes the purchase of the particular item associated with the first item ID. Step 250 may also include updating hyperlink database data stored at database 125 of FIG. 1. This hyperlink database data may cross-reference the item ID, with the item name, referral codes, user IDs, and generated hyperlinks. For example, a hyperlink of https://www.vons.com/pharmacy/coldmedicine that points to a product offering for a cold medicine sold at an online pharmacy operated by 3^{rd} party vendor Vons could be modified to include other information, such as https://MLM.vons.com/pharmacy/coldmedicine/iIDX_RcdY_. . . . This modified hyperlink may point to an administration computer associated with an MLM organization selling a cold medicine product assigned an item identifier of “iIDX” and a referral code “RcdY.” Such a modified hyperlink could direct a user device to access the administration computer that in turn would redirect the user device to a webpage where the cold medicine could be purchased. After a downline user purchases the product, an upline user associated with referral code “RcdY” may receive a commission.

This referral code may be referred to as a “child code” that may be generated whenever a particular user or user device orders a particular product a first time. Because of this, the process of generating the hyperlink may also include generating a child code that may be stored as a referral code with hyperlink database data. After step 250 of FIG. 2, program flow may move back to step 220 where another item ID may be identified in the landing page product data.

These child codes discussed above may be generated by various methods, such as using a random number generator, for example from a seed that may include a portion of the product ID. A child code may alternatively be generated from product data or a hash of product data. When a random number generator is used to generate a child ID, the child ID may be required to have a minimum length in order to limit the likelihood of generating a child code that has already been used. A hash of product data may be generated from using any combination of a product name, the product ID, user information, or other data. Generated child codes may also be checked to see that no other identical child code is stored at the database in step 250. In an instance where a particular child code has already been used, another child code may be generated.

Newly generated child codes may be associated with one or more parent codes that are associated with a chain of users that purchased a particular product. For example, a child code may be associated with a parent code of a first upline user that sent marketing materials to a user device associated with the child code and this child code may be associated with a second upline user that sponsored the first upline user to purchase a product associated with these child and parent codes. When a new child code is generated for a new user, users upline of that new user may be paid commissions according to a commission schedule. As such, the first and the second upline user associated with the product and a child code may receive commissions based on a new user purchase. Also, whenever a particular user purchases a product they may be provided with a discount and users that are upline of that user may receive commissions.

Some products may also be associated with a plan that automatically initiates products to be purchased after a time period has expired. For example, disposable products such as razor blades may be automatically generated each month based on a plan that a user participates in. Here each time a recurring purchase is made, commissions may be distributed to users that are part of a particular tree of related users that each purchased those razor blades.

When determination step 230 identifies that the received product ID matches data stored at the database, program flow may move to determination step 240 that identifies whether the received product data includes another item ID that needs to be reviewed. When yes, program flow may also move back to step 220 where another item ID may be identified in the landing page product data. When determination step 240 identifies that there is not another item ID to review, program flow may move back to step 210 of FIG. 2 where additional product data is received.

After a new entry has been created in the database, a new hyperlink may be generated. The generation of this new hyperlink may include combining the URL that identifies a landing page associated with the product ID with the product ID and with the child code generated in step 250. Hyperlinks stored at the database of the administration network may include a concatenated set of information that includes the URL, the product ID, and the child code. A generated hyperlink may be compatible with any format used in the art and may cross-reference items for sale (goods or services) and with addresses of webpages where sellers may of relevant items may be offered for sale by way of a seller computer that may provide an application program interface (API) for users to interact with. The process of generating a new hyperlink may include modifying a URL that identifies a webpage hosted by a 3^{rd} party computer, as discussed above.

Functions that track activity of users that select a generated hyperlink may also be tracked by a computer such as administration computer 105 of FIG. 1 using this hyperlink database data. Here, a program code associated with such functions may be used to track user activity. A user device that has received a selection to view a webpage identified by a modified URL (a generated hyperlink) may be sent a cookie that may be attached to a web browser operational at the user device. This process may include retrieving a cookie or other data from a user device. This cookie or other data may be retrieved by an administration computer before the administration computer redirects the web browser of the user device to a computer of a 3^{rd} party that offers items for sale. This cookie or data may then be used to track actions performed by the user device. Information that associates this cookie with the user device and with the 3^{rd} party computer or item may be stored at a database of the administration computer. At this point in time, the administration computer would have received information regarding the fact that a particular user device initiated an access to view a particular product offering. Data collected by the administration computer may include the cookie, a code associated with the user device or with a user, a parent code associated with another user or other user device, and information associated with the product offered at the 3^{rd} party website.

Table 3 illustrates an exemplary set of data that may be used to track the activities of products sold by various individual distributors. A first row of table 3 includes a series of column headers that are used to cross reference item identifying numbers (IDs), product names, parent codes, child codes, user identifiers (IDs), and specific generated hyperlinks (URLs). Note that the rows 2-4 of table 3 include information that identifies sales of a type of cold medicine. First of all, a user with user ID “Kwik” purchased cold medicine with item ID of 456812. This first user is associated with child code ai9ufy6HE4. Since this first user was a first user of a new user product tree selling cold medication with item ID 456812, no parent code is associated with this purchase. The hyperlink in the second row of table 3 identifies an administration computer “Kwik,” a third party seller/store of “Vons,” product ID 456812, and child code ai9ufy6HE4.

The hyperlink in the third row of table 3 may have been provided to a user device belonging to a prospective buyer of the cold medicine assigned item ID 456812. The user device of this prospective buyer may have received marketing materials prepared by the user assigned with user ID “Kwik.” Later when this prospective buyer purchases the cold medicine, this prospective buyer may be assigned user ID HF4875 and child code LmPwRESpH. Since this prospective buyer in now an actual buyer, they may be considered a new member of a multilevel marketing tree associated with parent ID ai9Ufy6He4 (that belongs to user ID “Kwik”). Based on this chain of events, a person with user ID “Kwik” may receive a commission based on the sale of the cold medicine to a person with user ID HF4875.

The data stored in the third row of table 3 is a record of a chain of sales as this third row of data indicates that the person assigned user ID HF4875 purchased cold medicine 456812 based on a referral made using code ai9ufy6HE4. The parent code included in this third row being the same as the child code of the second row of table 3 may be used to identify which users should receive commissions for sales that they sponsored. Note also that the hyperlink included in the third row of table 3 identifies the “Kwik” administration computer, the “Vons” third party seller, the cold medicine product name, the cold medicine product ID, and the child code LMPwRESpH. In an instance when this hyperlink is used to sell the cold medicine with product ID 456812 to another new user, users associated with user ID HF4875 and user ID Kwik may each receive commissions based on this new sale.

Table 3 also tracks the sale of other products associated with other item IDs, parent codes, child codes, user IDs, and hyperlinks. Parsing of this information may be done to identify particular users that have or that should receive commissions. Note that user with code sZa2q6jDuo is credited with selling couch 123789 to buyers with child codes IvOdgpFsJ5 and ogV1LAwT50. Note also that the buyer with child code IvOdgpFsJ5 does not have a user ID based on the not applicable/available (N/A) identifier being listed as a user ID.

Note also that user with user ID Kwik purchased table saw 789654, that a buyer with child code g05HfVMC purchased this same type of table saw, and that the buyer with child code g05HfVMC is also associated with selling that same type of table saw to a user with user ID VY0093 and child code z4jjna7t3c.

Each of the upline distributors/users may receive commissions identified based on parsing of respective child codes, related parent codes, and item identifier codes. For example, a user assigned user ID Kwik may receive commissions for the cold medicine purchased by users associated with both user ID HF4875 and YD9483 and a user associated with user ID HF4875 may receive a commission based on the user associated with user ID YD9483 purchasing the cold medication. Here again, commissions further from the actual purchase may be reduced or paid out based on a commission schedule.

TABLE 3
Administration Network Hyperlink/Tracking Database Data

| | Product | | | | |
|---|---|---|---|---|---|
| Item ID | Name | Parent Code | Child Code | User ID | Hyperlink |
| 456812 | Cold | N/A | ai9ufy6HE4 | Kwik | https://kwik.vons.com/pharmacy/coldmedicine/? |
| | Medicine | | | | kwikcode=456812ai9ufy6HE4 |
| 456812 | Cold | ai9ufy6He4 | LmPwRESpH | HF4875 | https://kwik.vons.com/pharmacy/coldmedicine/? |
| | Medicine | | | | kwikcode=456812LmPwRESpH |
| 456812 | Cold | LmPwRmESpH | H23s123Dxx | YD9483 | https://kwik.vons.com/pharmacy/coldmedicine/? |
| | Medicine | | | | kwikcode=456812H23s123Dxx |
| 123789 | Couch | N/A | sZa2q6jDuo | Kwik | https://kwik.bobsfurniture.com/ . . . /? |
| | | | | | kwikcode=123789sZa2q6Duo |
| 123789 | Couch | sZa2q6jDuo | IvOdgpFsJ5 | N/A | https://kwik.bobsfurniture.com/ . . . /? |
| | | | | | kwikcode=123789IvOdgpFsJ5 |
| 123789 | Couch | sZa2q6jDuo | ogV1LAwT50 | MF1192 | https://kwik.bobsfurniture.com/ . . . /? |
| | | | | | kwikcode=123789ogV1LAwT50 |
| 654123 | Drill | N/A | eyySAh0ijh | Kwik | https://kwik.homedepot.com/ . . . /? |
| | | | | | kwikcode=654123eyySAh0ijh |
| 654123 | Drill | eyySAh0ijh | D5Tn6nQq70 | HG9873 | https://kwik.homedepot.com/ . . . /? |
| | | | | | kwikcode=654123D5Tn6nQq70 |
| 654123 | Drill | N/A | EejbIOK3Uu | JD4483 | https://kwik.homedepot.com/ . . . /? |
| | | | | | kwikcode=654123EejbIOK3Uu |
| 789654 | Table | N/A | WLW2AaMQ6Q | Kwik | https://kwik.homedepot.com/ . . . /? |
| | Saw | | | | kwikcode=789654WLW2AaMQ6Q |
| 789654 | Table | WLW2AaM6Q | g05HfVMC | N/A | https://kwik.homedepot.com/ . . . /? |
| | Saw | | | | kwikcode=789654g05HfVMC |
| 789654 | Table | g05HfVMC | z4jjna7t3c | VY0093 | https://kwik.homedepot.com/ . . . /? |
| | Saw | | | | kwikcode=789654z4jjna7t3c |

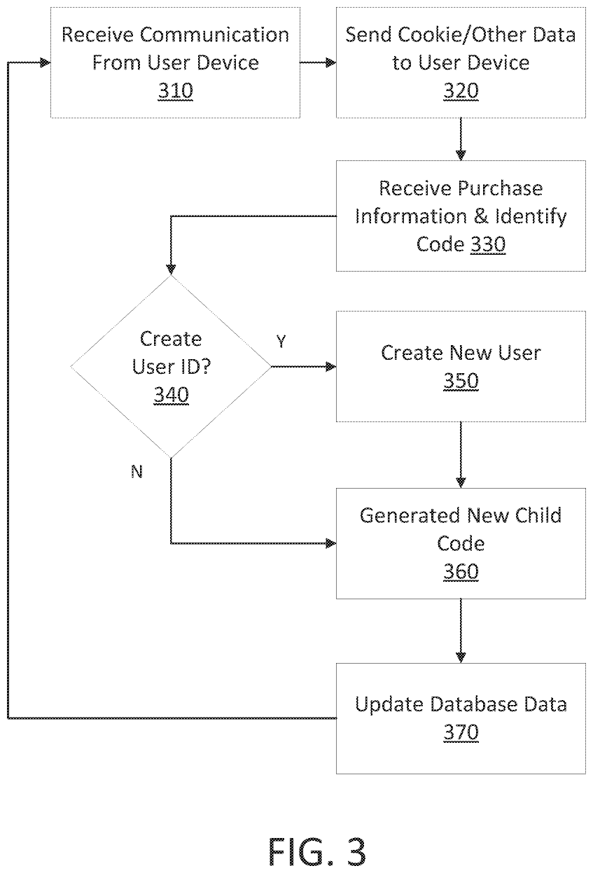

FIG. 3 illustrates a series of actions that may be performed when user activity is tracked. FIG. 3 begins with step 310 where a communication is received from a user device by an administration computer. This communication may have been received based on a user of the user device selecting a hyperlink included in marketing materials displayed on a display of the user device. This hyperlink may be the hyperlink generated in step 250 of FIG. 2. This hyperlink could point to a computer of an administration network and this hyperlink could include or be associated with information that identifies an online store, a product or a service, and may also include a user code (a child and/or a parent code) as described in respect to the information included in table 3. After the communication is received, a cookie and/or other information may be sent to the user device in step 320. The cookie or information sent to the user device may be used to track actions performed by the user device. Step 320 may also include generating a child code to associate with the user device and this child code may be included in the information sent to the user device in step 320. This tracking could include either an administration computer accessing the cookie information or may include a 3^{rd} party computer accessing this cookie information to cross-reference user information, product information, and purchase information such that commissions may be distributed.

A sale of a product associated with the selected hyperlink may then be processed. This may include forwarding the user device to a computer of a third (3^{rd}) party vendor that receives information from the user device indicating that the owner of the user device wishes to purchase the product. As mentioned above, this 3^{rd} party computer may receive cookie information stored at the user device when user activity is tracked. In such an instance, the 3^{rd} party vendor computer may send information to the administration computer indicating that the sale of the product has been completed. The data received from the 3^{rd} party vendor may identify the child code, an identifier of the user device that was used to purchase the product or service, a user ID, or some combination of data associated with the sale. In yet other instances, the administration computer itself may administrate the sale of the product without forwarding the user device to a 3^{rd} party vendor computer.

After a new buyer purchased the product, information relating to the sale of the product or service may be received and a code associated with the sale may be identified in step 330 of FIG. 3. This code may be the child code that was included in the URL that the user device used to access the administration computer and this code may be identified as a parent code to include in a new database entry used to track the sale of the product. Program flow may then move to determination step 340 that may identify whether the new buyer wishes to receive a user ID, when yes, program flow may move to step 350 where a new user ID is created and assigned to the buyer.

After step 350 or when step 340 identifies that the new buyer does not want to receive a user ID, program flow may move to step 360 where a new child code is generated. Step 360 may also include generating an updated hyperlink that may point to the administration computer, that identifies a 3^{rd} party vendor computer, that identifies the product or service, and that includes the new child code. Next in step 370 data stored at the database may be updated to include an item ID, the child code, the user ID, a generated hyperlink, and possibly a parent code. Step 370 may store information that associates an item ID, a product name, the associated parent code, the newly generated child code, a user ID (when appropriate), and the newly generated hyperlink. After step 370, program flow may move back to step 310 where an additional communication may be received from a user device. While not illustrated in FIG. 3 other actions performed by an administration computer may include authorizing the distribution of commissions.

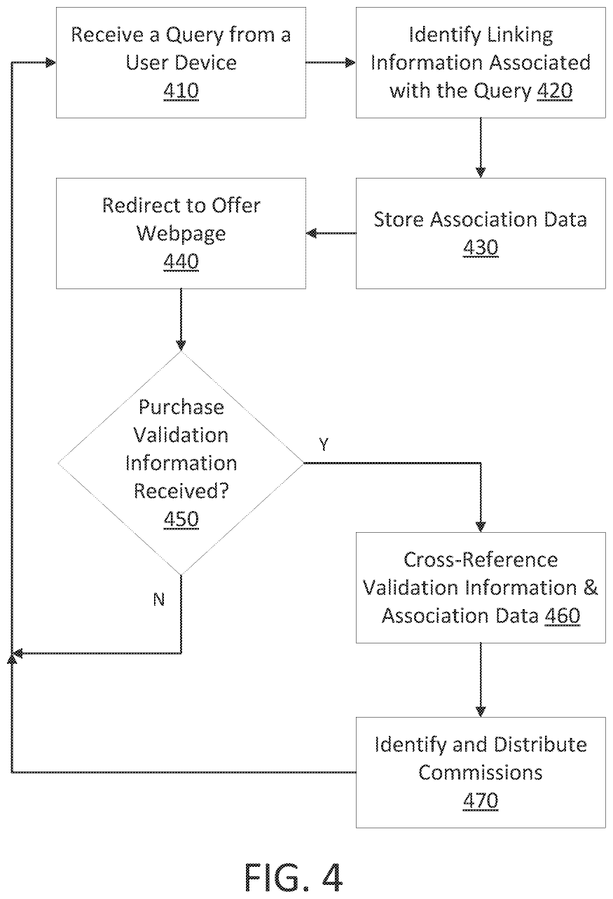

FIG. 4 illustrates steps that may be performed when purchase related activities of a user are tracked. Tracking functions associated with operations performed by the steps of FIG. 4 may be performed by instructions associated with an administration network hyperlink tracking module, where these instructions may direct a browser to an internet protocol (IP) address based on a domain name server (DNS) server database. This may be accomplished using a protocol associated with a generated hyperlink or URL. This hyperlink may direct be directed to a DNS server in order to identify an IP address of a webpage of a vendor. In another instance, a URL in the generated hyperlink directs a browser to a webpage which redirects the browser to the webpage of a vendor.

FIG. 4 begins with step 410 where a query is received from a user device. This query may be received after a user clicks on a hyperlink included in marketing materials that were received by a device owned by the user. This hyperlink may have been generated in step 250 of FIG. 2 and this hyperlink may be associated with a user ID, a child code, and a product. This hyperlink may also be associated with a parent code or with a cookie. As discussed in respect to table 3, the parent code may be associated with the product after a first user purchased the product, after the first user referred the product (e.g. item ID) to a second user, and after the second user purchased the product. The association of the hyperlink with the cookie may be the cookie sent to the user device in step 320 of FIG. 3. This cookie may include the information that associates the product with the user ID, the child code, and the hyperlink. As such, retrieval of the cookie from the user device may help the administration network computer 105 or 3^{rd} party network computer 150 of FIG. 1 identify that the hyperlink selected by the user at the user device is associated with the user ID, the child code, and the product. Sep 410 may include actions not illustrated in FIG. 4 as step 410 may receive hyperlink information and may receive information associated with the cookie. The administration network computer may then identify linking information associated with the query in step 420 of FIG. 4 and the network administration computer may store data that identifies one or more of the user ID, the child code, a vendor, and an item/product identifier at a database. This information may be stored in step 430 as a possible pending purchase associated with the user device (or with a user of the user device) from which the query was received in step 410. Next in step 440, the administration computer may redirect the query received in step 410 such that a browser of the user device from which the query was received to be directed to a webpage in step 440 of FIG. 4.

To accomplish the redirection of step 440, the administration computer may direct the browser of the user device to access a webpage hosted by a 3rd party computer and that third party computer may send an offering to purchase the product to the user device of the user. This 3^{rd} party computer may access the cookie information when tracking user activity. After this the user may by way of the browser at the user device purchase the product. When a user purchased the product the 3rd party computer may receive funds associated with the purchase and may arrange for the product to be provided to the user (by way of delivery or pick up for example). Either after the user agrees to purchase the product or after the user receives delivery of the product, the 3rd party computer may send purchase validation information to the administration computer such that commissions may be provided to eligible product distributors/users. Here the purchase validation may be associated with a user based on cookie information retrieved from a user device by the 3^{rd} party computer.

The redirection process performed by the administration computer may alternatively include sending information that identifies the item ID, the child code, the user ID, and possibly other information to the 3rd party computer. The information sent to the 3rd party computer would allow the 3rd party computer to provide information that verifies the purchase and that allows the administration computer to identify the particular product commission tree that the purchase is associated with. Alternatively, information provided to the 3rd party computer may be simply a transaction number or hash of data that the third party computer could send back to the administration computer such that the administration computer can identify the particular product commission tree that the purchase is associated with. Such a transaction number could be a random number or a number that is incremented for each respective potential purchase. When a hash is used, that hash could be a hash of the user item/product ID, the child code, and the user ID discussed above. The steps discussed above performed by the 3rd party computer could alternatively be performed by the administration network computer or could be performed by another computer at an administration computer network.

After step 440, program flow moves to determination step 450 where identifies whether purchase validation information has been received from a 3rd party computer, from another computer at the administration computer network, or from process at the administration network computer. When validation information has been received program flow may move to step 460 where the validation information is cross-references with data associated with the product and with the query received in step 410. In certain instances, program flow could continue checking to see if purchase validation information has been received by iteratively implementing determination step 450. Alternatively, whenever a purchase validation is received, data included in a set of received purchase validation information may be used to cross-reference a validated purchase with other data. Step 460 of FIG. 4 is a step where the received validation information is cross-referenced with associated data. This process may include comparing the validation information with store item IDs, child codes, user IDs, and possibly hyperlink information with data stored at the database of the administration computer. Step 460 may identify a particular row of table 3. Next in step 470 individuals or user devices to which commissions should be distributed may be identified and any appropriate commissions could be distributed in step 470 of FIG. 4.

Here again the distribution of commissions may include parsing a product tree using product identifying information, parent codes, child codes, and user IDs as required. After step 470 program flow may move back to step 410 where another query may be received.

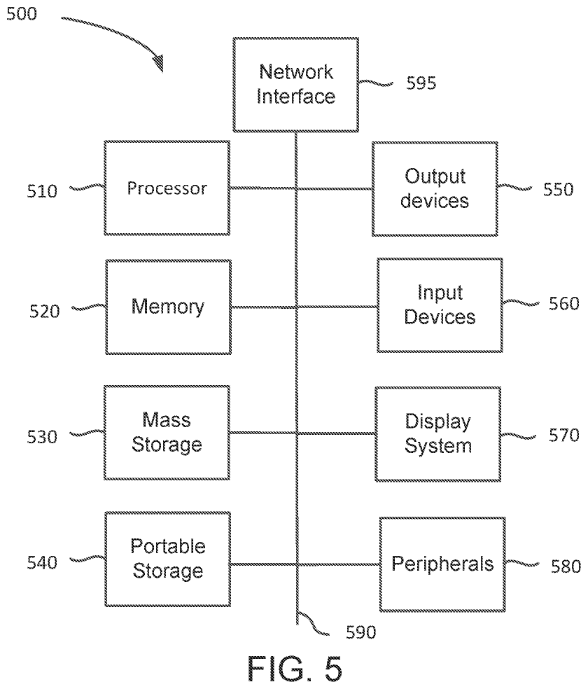

FIG. 5 illustrates a computing system that may be used to implement an embodiment of the present invention. The computing system 500 of FIG. 5 includes one or more processors 510 and main memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 550, peripheral devices 580, and network interface 595.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 550 may be connected via one or more input/output (I/O) buses.

Mass storage device 530, which may be implemented with a magnetic disk drive—an optical disk drive—or FLASH memory, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a FLASH memory, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 550 may include a liquid crystal display (LCD), a plasma display, an organic light-emitting diode (OLED) display, an electronic ink display, a projector-based display, a holographic display, or another suitable display device. Display system 550 receives textual and graphical information and processes the information for output to the display device. The display system 550 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

Network interface 595 may include any form of computer interface of a computer, whether that be a wired network or a wireless interface. As such, network interface 595 may be an Ethernet network interface, a BlueTooth™ wireless interface, an 802.11 interface, or a cellular phone interface.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 500 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The functions performed in the processes and methods which may be implemented in differing order. Furthermore, the outlined steps and operations are only provided as examples, and some of the steps and operations which may be optional, combined into fewer steps and operations, or expanded into additional steps and operations without detracting from the essence of the disclosed embodiments.

What is claimed is:

1. A method for using custom hyperlinks to track product sales, the method comprising:
identifying an item identifier (ID) associated with an online offer to sell the item and a universal resource locator (URL) that points to the online offer to sell the item;
generating a custom hyperlink associated with the item ID and the URL, wherein the hyperlink points to an administrative computer;
storing information that associates the generated hyperlink with referral information identifying a set of distributors that previously purchased the item and that belong to a same multi-level marketing (MLM) tree;
redirecting a user device to receive the online offer based on receiving data indicating that the user device activated the hyperlink;
receiving purchase data that identifies that a user of the user device purchased the item via the online offer; and
retrieving the stored information associated with the hyperlink, wherein one or more commissions are allocated to the set of distributors based on receipt of the purchase data and in accordance with the stored information associated with the hyperlink.

2. The method of claim 1, further comprising assigning a child code associated with a first distributor of the set of distributors, the child code included in the referral information, wherein a first portion of the commissions is allocated to the first distributor.

3. The method of claim 2, further comprising identifying that a parent code is associated with a second distributor in the same MLM tree, wherein a second portion of the commissions is allocated to the second distributor.

4. The method of claim 3, wherein the first portion of the commissions is a different size than the second portion of the commissions based on a commission schedule associated with the item.

5. The method of claim 1, further comprising sending a cookie to the user device after receiving a query from the user device, wherein the cookie is associated with tracking information associated with tracking actions performed by the user device related to purchasing the item.

6. The method of claim 5, wherein redirecting the user device is further based on the tracking information associated with cookie.

7. The method of claim 1, further comprising retrieving cookie information from the user device, the cookie information indicating that user device previously accessed information regarding the item.

8. The method of claim 7, wherein redirecting the user device is further based on the cookie information.

9. The method of claim 2, further comprising:
assigning a second child code to associate with the user of the user device; and
storing additional information associated with the item ID and with the same MLM tree that includes the second child code, wherein the additional information also stores the child code as a parent code and identifies that the parent code is associated with the child code.

10. The method of claim 9, further comprising:
assigning a third child code to associate with a new user; and
storing additional information associated with the item ID and with the same MLM tree that includes the third child code, wherein the additional information also stores the second child code as a parent code of the second child code.

11. A non-transitory computer-readable storage medium for using custom hyperlinks to track product sales, the method comprising:
identifying an item identifier (ID) associated with an online offer to sell the item and a universal resource locator (URL) that points to the online offer to sell the item;
generating a custom hyperlink associated with the item ID and the URL, wherein the hyperlink points to an administrative computer;
storing information that associates the generated hyperlink with referral information identifying a set of distributors that previously purchased the item and that belong to a same multi-level marketing (MLM) tree;
redirecting a user device to receive the online offer based on receiving data indicating that the user device activated the hyperlink;
receiving purchase data that identifies that a user of the user device purchased the item via the online offer; and
retrieving the stored information associated with the hyperlink, wherein one or more commissions are allocated to the set of distributors based on receipt of the purchase data and in accordance with the stored information associated with the hyperlink.

12. The non-transitory computer-readable storage medium of claim 11, further comprising instructions executable to assign a child code associated with a first distributor of the set of distributers, the child code included in the referral information, wherein a first portion of the commissions is allocated to the first distributor.

13. The non-transitory computer-readable storage medium of claim 12, further comprising instructions executable to identify that a parent code is associated with a second distributor the same MLM tree, wherein a second portion of the commissions is allocated to the second distributor.

14. The non-transitory computer-readable storage medium of claim 13, wherein the first portion of the commissions is a different size than the second portion of the commissions based on a commission schedule associated with the item.

15. The non-transitory computer-readable storage medium of claim 11, further comprising instructions executable to send a cookie to the user device after receiving a query from the user device, wherein the cookie includes tracking information associated with tracking actions performed by the user device related to purchasing the item.

16. The non-transitory computer-readable storage medium of claim 15, wherein redirecting the user device is further based on the tracking information associated with the cookie.

17. The non-transitory computer-readable storage medium of claim 11, further comprising instructions executable to retrieve cookie information from the user device, the cookie information indicating that user device previously accessed information regarding the item.

18. The non-transitory computer-readable storage medium of claim 17, wherein redirecting the user device is further based on the cookie information.

19. The non-transitory computer-readable storage medium of claim 12, further comprising instructions executable to:
assign a second child code to the user of the user device; and
store additional information associated with the item ID and with the same MLM tree that includes the second child code, wherein the additional information also stores the child code as a parent code and identifies that the parent code is associated with the child code.

20. The non-transitory computer-readable storage medium of claim 19, further comprising instructions executable to:
assign a third child code to associate with a new user; and
store additional information associated with the item ID and with the same MLM tree that includes the third child code, wherein the additional information also stores the second child code as a parent code of the second child code.
